(19) United States
(12) Patent Application Publication
(10) Pub. No.: US 2020/0289957 A1
(43) Pub. Date: Sep. 17, 2020

(54) CHROMATOGRAPHY COLUMN WITH LOCKED PACKED BED AND METHOD OF PACKING THAT COLUMN

(71) Applicant: Phenomenex, Inc., Torrance, CA (US)

(72) Inventors: Ismail M. Rustamov, Torrance, CA (US); Jeffrey A. Hayes, Torrance, CA (US); Emmet E. Welch, Torrance, CA (US); Phuong Boi Mai, Rolling Hills Estate, CA (US)

(21) Appl. No.: 16/886,500

(22) Filed: May 28, 2020

Related U.S. Application Data
(62) Division of application No. 16/115,992, filed on Aug. 29, 2018.
(60) Provisional application No. 62/552,918, filed on Aug. 31, 2017.

(51) Int. Cl. B01D 15/20; B01D 15/22; B01J 20/291; B01J 20/283

(52) U.S. Cl. CPC B01D 15/206; B01D 15/22; B01J 2220/56; B01J 20/283; B01J 2220/82; B01J 20/291

(57) ABSTRACT

A chromatography column has a retaining plug permanently fixed to an upstream end of the column and blocks one end of the bore through the column. The plug has a fluid passage therethrough. An upstream end of the passage is preferably but optionally larger in diameter than a downstream end of the passage. An upstream porous member upstream of the retaining plug is held by an upstream end cap and urged toward the plug. Chromatographic media extends from the upstream porous member, through the passage in the retaining plug, to a downstream porous member held by a downstream end cap. The media between the retaining plug and the downstream porous member are under compression to form a bed of packed media.

### CROSS-REFERENCE TO RELATED APPLICATIONS

The application claims the benefit under 35 U.S.C. § 119(e) to Provisional Patent Application No. 62/552,918 filed Aug. 31, 2017, the entire contents of which are incorporated herein by reference.

### STATEMENT RE: FEDERALLY SPONSORED RESEARCH/DEVELOPMENT

Not Applicable

### BACKGROUND

This application relates to a method and apparatus for packing tubular columns with chromatographic media, believed particularly suitable for high pressure liquid chromatography (HPLC) columns with media.

High pressure liquid chromatography (HPLC) columns contain a chromatographic media that forms a bed in the column with the bed located between two porous members such as screens or frits, typically made of glass, ceramic or metal. The media bed may be packed or unpacked. U.S. Pat. No. 5,186,826 is an example of an unpacked column where the column has enough head volume to allow the media to be manually shaken before each use.

For HPLC and UHPLC columns, voids in the chromatographic bed and non-uniformities in the bed can degrade performance of the column. For HPLC and UHPLC columns, packed beds with no void volumes are especially desirable and placing the bed in compression helps reduce such void volumes. Packed media beds may be formed by taking a column with a first porous member in one end, filling the column with media which is restrained by the first porous member, placing a second porous member on the other end of the media, and physically compressing the media between the two porous members using a ram or other compressing mechanism. U.S. Pat. No. 5,893,971 is one example of axial compression packing which retains a packing piston and mechanism in the column. That packing method causes an unnecessarily long and heavy column with costly hardware remaining in the column, all of which are not desirable.

The use of axial compression to compress the chromatographic beds of media works much better with non-porous substrates, but may work poorly with porous media and superficially porous (core-shell) media which lacks the compressive strength of non-porous media. This is especially true of silica media which crushes under sufficiently high compressive pressures and produces fragments or fines that can create non-uniformities in flow through the packed chromatographic bed or possibly clog the downstream porous member on the column. The porous and superficially porous chromatographic particles are often packed using slurry packing, in which a first porous member (e.g., frit) is placed in the downstream end of the column and a slurry of chromatographic media suspended in a fluid carrier (preferably a solvent), flows into the opposing, open end of the column, with the carrier fluid passing through the downstream porous member so the column fills with media packed by the flow of slurry and the pressure of the carrier fluid. When the column is filled to the desired degree, the slurry flow and fluid flow are stopped and a second, porous member is placed on the upstream end of the column.

Because the chromatography particles will not pass through the porous members, the upstream porous member is removed during slurry packing and is placed against the packed chromatography bed after slurry packing is complete. Unfortunately, when the fluid packing pressure is released the compressed bed expands so that before the upstream porous member can be added to the column, the bed expands and releases at least some of the compression achieved by the slurry packing pressure. This is described in U.S. Pat. No. 7,339,410, which removes the media extruded beyond the end of the column and adds a stepped porous member to slightly compress the bed adjacent the porous member. While that patent and others describe various ways to try and reduce the adverse effects of the bed expansion using slurry packing, simpler, faster and more consistent ways to pack the column bed are still needed. Thus, for a variety of reasons, simpler, faster and less expensive ways to reduce and retain the bed expansion of a packed chromatography bed are greatly desirable.

To address some of these difficulties with slurry packing, packing methods and resulting columns have been developed that use slurry packing but retain only the piston in the column, while leaving the majority of the packing mechanism outside of the column, as in U.S. Pat. No. 7,674,383. But this packing mechanism requires many parts and a locking system to retain the piston against the packed bed without releasing the pressure. There is thus still a need for a simple, less costly way to consistently pack these columns with chromatography media while maintaining a desirable compression on the chromatographic bed and increasing the density of the packed bed.

### BRIEF SUMMARY

A chromatography column is provided that has a tubular body with opposing upstream and downstream ends with upstream and downstream end fittings connected to the tubular body. The tubular body has an internal bore extending along a longitudinal axis of the tubular body and column. The column includes a retaining plug permanently fixed to the upstream end of the tubular body and blocking one end of the bore to prevent fluid passage past the retaining plug. The retaining plug preferably has a single fluid passage extending therethrough along the longitudinal axis, but the passage need not be so located or limited in so number. The retaining plug has opposing upstream and downstream ends with the fluid passage having a first diameter at the upstream end of the retaining plug and a second diameter opening at the downstream end of the plug. The column also has an upstream porous member upstream of the retaining plug and extending across the bore. The column has a downstream porous member extending across the bore at a location adjacent the downstream end of the tubular body. The tubular body has a continuous wall between the retaining plug and the downstream porous member (e.g., frit) so the bore bounds the flow path between the retaining plug and the downstream porous member (e.g., frit). Chromatographic media extends from the upstream porous member, through the passage in the retaining plug, to the downstream porous member, with no voids therein. The portion of the chromatographic media between the retaining plug and the downstream porous member is under compression and forms a bed of packed media.

Numerous variations of the fluid passage are available. The first diameter of the fluid passage may be the same as the second diameter. But the first, upstream diameter of the passage is advantageously larger than the second, downstream diameter of the passage. An upstream end fitting may hold the upstream porous member from moving in the upstream direction along the longitudinal axis. The fluid passage preferably has a conical portion on the upstream end of the retaining plug, which conical portion converges in a downstream direction to a smaller diameter. Further, the conical portion may extend from the upstream end to the downstream end of the retaining plug. The fluid passage may optionally have a cylindrical portion located downstream of the conical portion and joining an upstream end of the cylindrical portion. The fluid passage may have a diverging conical portion that expands in diameter toward the downstream end of the retainer plug. The conical portion may be in fluid communication with a concave recess in the downstream end of the retaining plug, which recess abuts the chromatographic media. The fluid passage may include a concave recess. The concave recess may include a recess having a cross-section taken along the longitudinal axis that comprises one of a parabolic shape or a circular shape. The first, upstream opening of the passage may be smaller in diameter than the second, downstream opening, but it believed preferable to have the larger opening of the passage on the upstream end of the passage.

In further variations, the downstream end of the fluid passage may have an opening that is about ⅕ to about ⅓ the diameter of the bore for openings up to about 14 mm in diameter. The downstream end of the fluid passage may alternatively have an opening that is about ½ to ¾ the diameter of the bore. The retaining member may optionally have a plurality of fluid passages, each having a minimum passage diameter, which minimum diameters are preferably but optionally the same. The chromatographic media may further comprise a bed of porous particles, or a bed of superficially porous particles, or a bed of nonporous particles, or a bed of polymer particles, or a bed of silica particles, or a bed of hybrid organic/inorganic particles.

There is also advantageously provided an improved method of packing a chromatography column having a tubular body with a bore defining space for a packed bed of chromatographic media located between a downstream porous member filtering all flow through the bore and preferably extending across the bore and an upstream retaining plug fastened to an upstream end of the tubular body and blocking flow through the bore except for a fluid passage through the retaining plug. The method may include the steps of passing a slurry of solvent and chromatographic particles through the fluid passage under a predetermined packing pressure greater than 100 psi to form a packed bed of chromatographic media between the downstream porous member and the retaining plug. The fluid passage preferably has an upstream opening on an upstream face of the retaining plug and a downstream opening on a downstream face of the retaining plug, with the upstream and downstream openings being centered on a longitudinal axis of the tubular body. The retaining plug is permanently fastened to the tubular body.

The method also includes stopping the flow of the slurry and solvent when a compressed chromatographic media bed is formed between the retaining plug and the downstream porous member and when compressed media particles fill the fluid passage and possibly any portion of the column upstream of the retaining plug. The bed may expand into the downstream opening of the fluid passage when flow of slurry and solvent is stopped. After the flow of slurry is stopped, an upstream porous member is placed over the bore at a location upstream of the retaining plug and in contact with the chromatographic media with no void spaces between the upstream porous member and the adjacent chromatographic media. The method also includes the step of fastening the upstream porous member to the column. The retaining plug restrains expansion of the bed downstream of the plug and the upstream porous member restrains expansion of the media in the passage.

In further variations of the method, the fastening step preferably includes urging a frit retainer against the upstream porous member and fastening the frit retainer to the tubular body to restrain motion of that porous member. The variations also include using a retaining plug having the upstream opening larger in diameter than the downstream opening. The downstream opening is smaller than the bore through the tubular body and the portion of the retaining plug adjacent the downstream opening preferably restrains bed expansion of at least part of the packed chromatographic bed in a direction along the longitudinal axis. The packing pressure is preferably between about 10,000 psi and about 25,000 psi. The chromatographic media used in the method may include a porous media with a pore size of at least 2 nm, or superficially porous particles, or porous particles. The chromatographic bed preferably has no void volumes.

The method may further include the step of scraping off any media extruded above the top surface of the retaining plug before the placing step and after the fastening step.

There is also provided a chromatography column packed by one or more of the above methods. Such a packed column is believed to have improved density of the packed chromatography bed compared to columns packed without the retaining plug, and are also believed to have improved interlocking of the chromatographic media, as well as other advantages described herein. The packed column may include a packed chromatography bed of porous silica particles with a pore size of at least 2 nm, or it may include packed polymer particles, or packed silica particles, or a packed bed of porous particles, or a packed bed of superficially porous particles.

There is also provided a chromatography column that includes a tubular body having opposing upstream and downstream ends and a cylindrical bore extending along a longitudinal axis of the tubular body between the upstream and downstream ends. A retaining plug having an outer periphery is permanently fixed to the bore adjacent the upstream end of the tubular body in a fluid tight manner. The retaining plug may have a single fluid passage extending through the retaining plug and along the longitudinal axis. The fluid passage has an upstream opening and a downstream opening. The column also has a downstream porous member extending across the bore adjacent the downstream end of the tubular body. The downstream porous member is configured to block the passage of chromatographic media while allowing liquid and gas to pass through the downstream member. The column also includes a downstream end cap connecting the downstream porous member to the downstream end of the tubular body.

In further variations, the entire tubular body is preferably metal. The fluid passage may have various configurations, including a configuration where the downstream end of the fluid passage has a diameter that is smaller than a diameter of the upstream end of the passage. That is, the upstream opening is larger in diameter than the downstream opening. The retaining plug preferably has an upper surface that is flush with the upstream end of the tubular body. The retaining plug may also have a hat shaped cross-section with a downstream portion extending inside the bore of the tubular body and an upstream portion extending over an end of the tubular body and permanently fastened thereto. The column may have an upstream porous member upstream of and urged toward the retaining plug by an upstream end cap that urges a frit retainer toward the porous plug. The fluid passage is preferably filled with chromatographic media and the bore between the downstream porous member and the retaining plug are preferably filled with chromatographic media under compression. The column is preferably filled with silica chromatographic media, or polymer chromatographic media, or porous chromatographic media, or superficially porous chromatographic media.

### BRIEF DESCRIPTION OF THE DRAWINGS

These and other advantages and features of the invention will be better appreciated in view of the following drawings and descriptions in which like numbers refer to like parts throughout, and in which:

FIG. 1 is a cross-sectional view of a chromatography column with a retaining plug in a recess at one end of a packed chromatography bed;

FIG. 2 is a cross-sectional view of chromatography column with a T-shaped retaining plug at one end of a packed chromatography bed;

FIG. 3 is an enlarged view taken along section 3-3 of FIG. 2;

FIG. 4 is an enlarged view taken along section 4-4 of FIG. 1;

FIGS. 5A-5I are cross sections of retaining plugs showing different shapes of passages through the retaining plug;

FIG. 6A is a sectional view of a chromatography column with a compression end fitting; and

FIG. 6B is an enlarged sectional view taken along 6B-6B of FIG. 6A.

### DETAILED DESCRIPTION

As used herein, the following parts have the following part numbers: 9—tubular body; 10—column; 12—threads; 14—first porous member; 16—second porous member; 18—retaining plug; 20—first end fitting; 21—shoulder; 22—second end fitting; 23—media; 24—media bed; 26—passage through retaining plug 18; 28—sealing rings; 30—frit retainer; 40—inlet portion; 42—cylindrical portion; 44—outlet portion; 46—spherical inlet; 48—parabolic inlet; 56—shoulder; 58—smaller diameter portion; 60—larger diameter portion; 66—compression end fitting; 68—nut; 70—sidewall; 72—bottom; 74A—threads; 76—ferrule; 77—conical surface; 78—fitting body; 80—gripping surface; 82—connector passage; and 84—conical surface.

Referring to FIGS. 1-4, a chromatography column 10 having a tubular body 9 with a longitudinal axis 11, and optional external threads 12 on opposing first and second ends of the tubular body 9. As used herein, the upstream and downstream directions refer to the directions relative to the flow during packing of the column. The flow direction of the packed column 10 during use may differ from the packing flow directions. The relative directions of up and down, upper and lower, above and below, top and bottom, refer to the directions of the parts when the column 10 is in the vertical direction during packing, with the upstream end pointing away from the earth.

The packed column 10 has first and second porous members 14, 16 at the respective first (upstream) and second (downstream) ends of the tubular body and column. A retaining plug 18 is shown inside the tubular body 9 and fixed to the first end of the tube 9, with a fluid passage 26 having various possible shapes (as discussed later) extending through the plug 18. A first end fitting 20 holds the first porous member 14 in place and preferably urges the porous member 14 toward the upstream end of the retaining plug 18, preferably by engaging threads 12 on body 9 to move that end fitting and porous member toward the fixed retaining plug 18. A second end fitting 22 engages corresponding threads on the second, downstream end of the tube 9. The first and second end fittings 20, 22 preferably provide fluid connections between the column 10 and various chromatography related instruments, analytical instruments and packing equipment. Appropriate sealing rings 28, typically O-rings 28, may optionally be used as needed to prevent fluid leakage, with frit retainers 30 typically held in position inside each end fittings 20, 22 to facilitate fluid connections with equipment, such as analytical equipment and possibly packing equipment. The end fittings 20, 22 are also typically of metal.

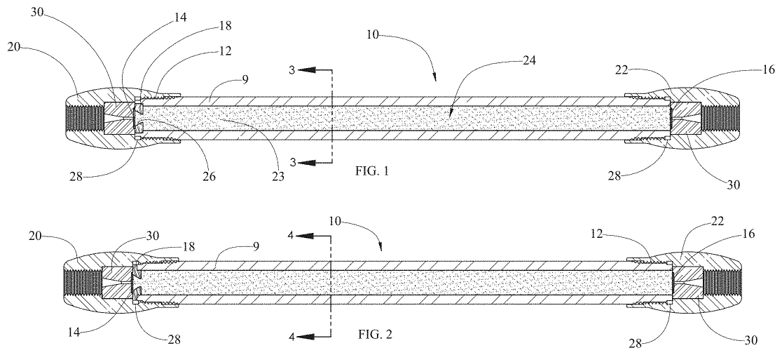

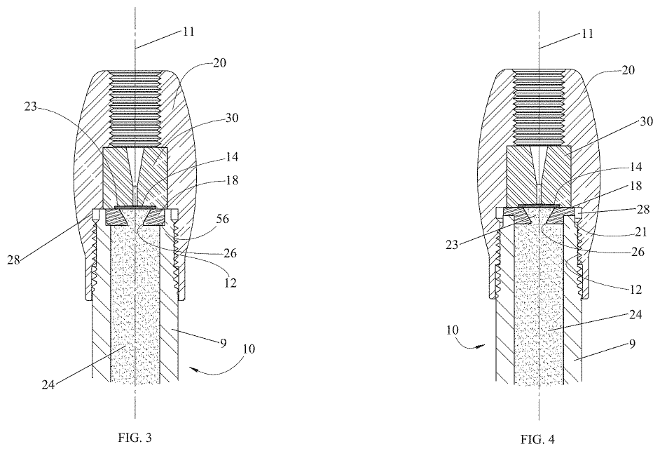

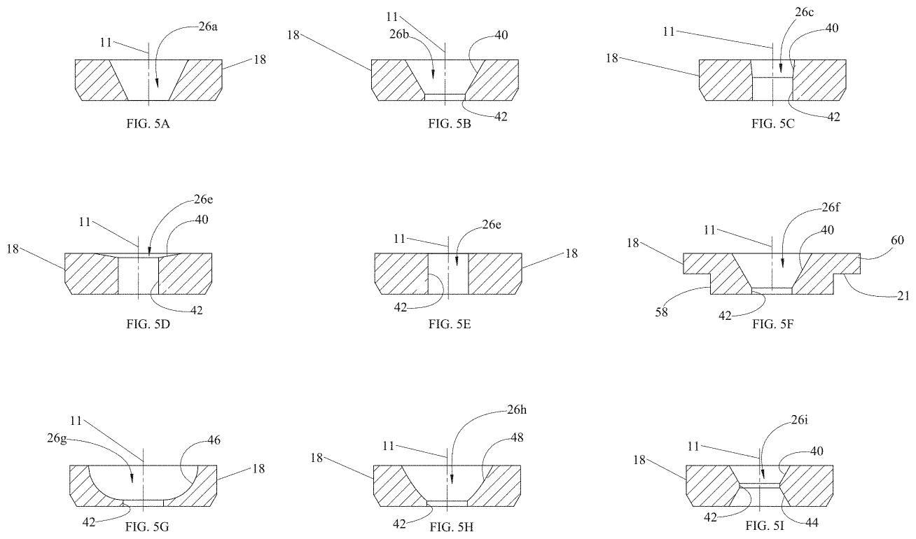

The porous members 14, 16 are typically metal, glass or ceramic filters or frits that allow liquids and gases to pass but prevent passage of chromatographic particles. The retaining plugs 18, are typically of two general types, the first of which is shown in FIGS. 1 and 4, having a generally circular outer periphery that bounds opposing, flat, top and bottom sides and results in a disk-shaped part. The resulting disk shape fits into a mating cylindrical recess in the upstream end of the tubular body 9 as in FIGS. 1, 4, 5A-5E and 5G-5I. The second general type is a T-shaped cross-sectional shape (FIGS. 2, 4 and 5F) with a larger diameter on top and a smaller diameter on the bottom and results in a stepped—diameter, disk—shaped part with flat shoulder 21 (FIG. 5F) joining the two peripheral sides. In use, the resulting stepped—shaped disk fits the smaller, downstream disk into a mating, cylindrical recess in the upstream end of the body 9 with the larger diameter portion of the disk extending over an end of the tubular body 9 or possibly into a stepped-recess (not shown) in the end of the body 9 as in FIGS. 2 and 3. One or more corners of the retaining plug 18 may be broken or chamfered to remove sharp corners and ensure a smooth fit with mating recesses and adjoining surfaces.

The fluid passage 26 may extend axially through the retaining plug 18 and is in fluid communication with and preferably axially aligned with the axis 11 of bore 9 and column 10. When packed with media 23 to and through at least part of the passage 26 to form the chromatographic bed 24 below the retaining plug 18, the column 10 has the retaining plug 18 abutting a slurry-packed media bed 24 so the first porous member 14 and the retaining plug 18 restrain axial expansion of that slurry-packed media bed 24. Some media from the bed 24 usually extrudes into the fluid passage 26 when the packing pressure is removed and the media in passage 26 also expands when released from the packing pressure. The first porous member 14 is upstream of the retaining plug 18 and restrains expansion of the media 23 in the passage 26 when the member 14 is held in place. The main and predominant portion of the slurry packed media bed 24 is between the retaining plug 18 and the second, downstream porous member 16 so the media bed 24 is held in compression in the column by the downstream porous member 16 and retaining plug 18. The compression of the bed of media does not include the atmospheric pressure. The fluid passage 26 is also packed with chromatographic media 23 but it is typically not at the same pressure as the packed bed 24. In some configurations, it is possible that a very short distance of the tubular body 9 located upstream of the top surface of the retaining plug 18 is also filled with chromatographic media, but it will be at the same, lower compaction pressure as the passage 26. The media particles 23 may be silica or polymer particles, and may be non-porous particles, superficially porous (core-shell) particles, or porous particles, silica gel or modified silica gel, surface modified silica gel, silica gel based chromatographic media, or organic/inorganic hybrid particles. As used herein, porous media refers to media that is totally porous and does not include core-shell media or superficially porous media.

The tubular body 9 has a continuous sidewall between the retaining plug 18 and the downstream porous member 14. Thus, the bore through the body 9 defines the outer periphery of the flow path between the retaining plug 18 and the downstream porous member 14. Alternately phrased, the column preferably has no lateral fluid paths in fluid communication with the bore through the column 9 at any location between the retaining plug 18 and the downstream porous member 14. Thus, all chromatographic media forming the packed bed 24 passes through the passage 26 of the retaining plug 18. When packed, the upstream porous member 14

Because void spaces in the chromatographic media are undesirable, it is preferable to have the upstream porous member 14 abut and at least slightly compress the chromatographic media in the passage 26 and any such media upstream of the retaining plug 18, but preferably without breaking the media and generating fines. Because the pressure that fractures the chromatographic media 23 will vary with the media type and properties of the particular media used, the amount of media between the top of the retaining plug 18 and the bottom of the porous member 14 will vary. Thus, the resulting distance between the top of the retaining plug 18 and the bottom of the upstream porous member 14 may vary if any packing media 23 is located between the upstream surface of the retaining plug 18 and the downstream surface of the upstream porous member 14.

Porous media has a lower compression strength than does superficially porous media, and superficially porous media has a lower compression strength than does non-porous media. The basic material of the media also affects compressive strength and the resulting bed expansion, as for example, polymer media is more compressible than silica media and a compressed bed of polymer media may thus compress more and expand more than a bed of silica media of comparable particle size. The larger the pore size of porous media the lower the compression strength. The thickness of the shell, the pore volume and the size of the pores (created by the particles in the shell of a superficially porous material) also affect the compression strength of superficially porous particles. The packing pressure also varies, with higher pressures being used to pack smaller diameter particles, and used to achieve higher densities in the packed media bed 24.

Advantageously, the top or upstream end of the retaining plug 18 is preferably flush with the top or upstream end of the tubular body 9 of column 10. The slurry packing process typically provides an excess of chromatographic media 23. The excess media above the upstream end of the column can be scraped off and a porous plug 14 and end fitting 20 can be fastened to the column 10 and body 9, or if the upstream end of the porous plug is flush with the end of body 9 the extruded media can be scraped off laterally before the porous member 14 is fastened over the media and passage 26 to restrain further extrusion and loss of pressure on the packed bed. This is usually achieved by screwing the end fitting 20 onto the threads 12 on the body 9 of column 10, forcing the porous member 14 against the chromatographic media and often slightly compressing the media in the passage 26 and/or above the retaining plug 18, as the fitting 20 is tightened. It is believed desirable that the distance between the upstream porous member 14 and the top of the retaining plug 18 be as small as possible without generating an unacceptable amount or volume or number of fines when the porous member 14 is moved into position to maintain as much of the packing pressure established by the retaining plug 18 as possible. Sometimes the porous member 14 is sized to fit just inside the bore of the tubular body 9 either as a disc the size of the bore, or as a stepped portion of a two-diameter disk with the smaller diameter fitting inside the bore and the larger diameter abutting a shoulder on the tubular body.

Thus, there is preferably no media 23 between the top or upstream porous member 12 and the top of the retaining plug 18 and any media between the upstream and downstream porous members 12, 14 is compressed, with the chromatographic bed 24 being held in greater compression by the retaining plug 18 than the media in the passage 26. The downstream facing surface of the retaining plug restrains the bulk of the chromatographic bed 24 from moving axially upstream, with some media being extruded through the downstream opening of the passage 26 into that passage. It is believed that the media in the passage 26 is compressed between the upstream retaining member 12 and the packed bed 24 at a lower pressure or compression or density than the packed bed 24.

The top surface of the retaining plug 18 may be downstream of the top end of the tubular body 9, and if so it is preferably within a few millimeters of the top end. Preferably, the top surface is flush with the end of body 9 so removal of media 23 is simplified and achieved by scraping the extruded media off to one side. In either configuration with the retainer plug 18 flush with the top end of body 9 or recessed slightly downstream from that top end of body 9, the thickness of any layer of media 23 above the retaining plug 18, if any, is preferably such that tightening the first, upstream end fitting 20 to position the upstream porous member 14 does not crush any media 23 that is above the retaining plug 18 and below the upstream porous member 14 and thus creates no fines. Advantageously, the upstream porous member 14 abuts the top surface of the retaining plug 18, and optionally, the upstream porous member 14 is configured and located to fit slightly inside the upstream opening of the passage 26.

The passage 26 through the retaining plug 18 is filled with media 23 and the size and shape of that passage may affect the pressure on the media within that passage when the upstream porous member 14 is fastened to the column 10. It is desirable to crush as little of the particles of media 23 as practical and generate as few fines as possible while maintaining a sufficient pressure on the bed 24 and passage 26 to minimize expansion of the packed bed. It is also believed desirable to have the axial length of the retaining plug 18 be as short as possible.

Referring to FIGS. 5A through 5I, the passage 26 through the retaining plug 18 may have various configurations, with specific configurations referred to as passage 26a through 26i, and the retaining plugs in general referred to a retaining plug 18. The passage 26 through the retaining plug 18 is preferably wider at its upstream end and narrower at its downstream end so as to funnel the media 23 through the retaining plug 18 without clogging the passage during high pressure packing used to form the packed media bed 24 with no voids and a more densely packed bed than if the plug 18 is not used. The walls of the passage 26 are thus inclined but need not be straight as they are with a conical passage 26a (FIG. 5A), and may instead be curved (convex or concave) as is passages 26g and FIG. 5G. The minimum cross-sectional area of this passage 26a is determined by the area at the smallest diameter of the conical passage 26a, at the downstream end of the retaining plug 18.

Straight sided walls on the passage 26 are believed preferable from a manufacturing viewpoint because they are easier to make, although curved walls resulting from controlled movement of a spherical grinder are also believed suitable. The walls of the passage 26 are preferably smooth to facilitate passage of the slurry through the passage during high pressure packing, with walls polished to a surface finish of less than RA 8 micro inches believed desirable.

It is believed preferable to have a conical passage 26 extending from the upstream surface of the retaining plug 18 to the downstream surface of that plug. The passage 26 is discussed further below, but as an example, a cone 26a having an included angle of about 20° is believed suitable, when the retaining plug 18 is about 1.5 to 3 mm long measured along axis 11, and the column is about 4.6 mm in diameter. The larger, upstream diameter of the conical passage 26a is about 3 mm while the smaller, downstream diameter cone is about 1.5 mm when the retaining plug is about 1.5 mm in length measured along axis 11. For most slurries using particles sizes of 5μ or smaller, a minimum opening diameter for the passage 26 is believed to be about 1.5 mm for diameters of less than about 1 inch (about 25 mm).

To make the column 10, the retaining plug 18 with fluid passage 26 may be formed as a separate part which is then fixed in position in the bore of the tubular body 9, preferably permanently fixed in position. The retaining plug 18 is preferably of the same material as the tubular body 9, typically stainless steel but may alternatively comprise a metal which melts at a higher temperature than body 9 to facilitate permanent bonding by melted metal without risking deformation of passage 26. But the plug 18 may be made of other metals, including titanium, and for some applications may be a polymer, such as PEEK. For metal retaining plugs 18, a cylinder or disk is typically formed to the desired diameter with a desired outer surface finish and the fluid passage 26 is machined and/or ground through the retaining plug 18 and then polished to a desired smoothness, preferably under RA 8 micro inches. The retaining plug 18 may be machined, drilled and/or ground when the plug is already cut to the desired length or the plug may be cut to length from a longer cylindrical rod after the fluid passage 26 is drilled and/or ground or polished. Other manufacturing sequences to form the fluid passage 26 may be used and other ways to achieve a smooth surface on the wall of the passage may be used other than mechanical polishing, including chemical finishing. If the retaining plug 18 is a polymer, the passage 26 may be molded integrally with formation of the plug, in a single casting or molding operation.

Once the retaining plug 18 is formed, it is fixed to the tubular body 9 so that the plug 18 does not move and cannot move from the time the column is packed to form chromatographic bed 24, until the packed bed 24 is no longer used or needed. The columns 10 are typically stainless steel with polished internal bores extending along the axis 11 of the columns. The retaining plug 18 may be press fit into the upstream end of the column so the retaining plug 18 is held in position by an interference fit. The interference fit also provides a seal between the column and the periphery of the retaining plug 18 sufficient to withstand the operating pressure and packing pressure of the column without leaking, which pressures may be several thousand psi or kpa, as discussed later for silica gel and other particles, or several hundred psi for polymer particles.

As an additional step to ensure a fluid tight seal between the retaining plug 18 and the tubular body 9, a cure-in-place adhesive or sealant may be coated on the outside of the plug 18 before it is press-fit into place. It is believed possible to have the retaining plug 18 held in place in the tubular body 9 using only suitable adhesives (which include epoxies as used herein) which cure in place when the retaining plug 18 is positioned in place in the tubular body 9. Any fastening mechanisms using adhesives require a suitable strong and durable adhesive to last the life of the column, and one compatible with the intended use of the column. The adhesive may be used with any of the mechanical fastening mechanisms to provide an additional barrier against leakage during packing or use and/or to provide an additional fastening mechanism against movement.

The retaining plug 18 may also be welded or brazed into place, including friction welding. The contact length of the welded or brazed metal along the axis 11 is preferably the full length of the retaining plug 18, but may be less, although preferably not less than 0.005 inches (0.127 mm). It is believed possible, but less desirable to have internal or external threads on the tubular body 9 mate with correspondingly located threads on the retaining plug 18, preferably with at least two full threads engaged and more preferably with the entire exterior side of the retaining plug threaded and engaged with corresponding threads on the column. The threaded connection, as with the other types of connections, must be configured to accommodate the packing pressures and uses pressures without reducing the life of the column, e.g., through fatigue failure. If threaded connections are used the connections preferably include interference threads to lock the plug 18 relative to the body 9, or the exterior end of the plug may be deformed (e.g., upset or staked) to fix the parts relative to each other. The end of column 9 is preferably flat relative to axis 11, and as needed the end may be ground or otherwise finished as needed to function in the chromatography applications. It is also believed suitable to use adhesives to further ensure the leakproof seal of any threaded connection, or even and to position and fix the plug relative to the column.

The tubular body 9 may be configured to position the retaining plug 18 at a predetermined location along the axis 11 of the column by forming a position stop 56 (FIG. 3) in the tubular body 9. Similarly, the tubular body 9 may be configured to position the downstream porous member 16 at a predetermined location along the axis 11 in order to determine the length of the packed chromatography bed between the downstream porous member 16 and the retaining plug 18. As seen in FIGS. 3-4, this position stop is preferably formed as an annular, stepped recess in one or both opposing ends of the column to form a shoulder 56 or an axial stop which the downstream end of the retaining plug 18 abuts to position the retaining plug and define the length of the packed bed 24. The position stop 56 for the porous member 18 is thus preferably formed by drilling or reaming an annular shoulder coincident with the bore through body 9. The same type of annular shoulder or axial stop be formed for the downstream porous member 28 or the porous member may have an outer periphery held against the end of the tubular body 9 or otherwise held in position by frit retainer 30.

Referring to FIGS. 4 and 5F, the retaining plug 18 may have a stepped cross-section having a smaller diameter portion 58 that fits into the bore of the body 9 and column 10, and a larger diameter portion 60 that extends over at least part of the annular end of the tubular body 9, to form a hat-shaped cross section or a T-shaped cross-section. The larger diameter portion 60 forms a flange or shoulder 21 that may rest against the end of the body 9 or a shoulder of the body 9 to limit movement along axis 11 toward the downstream end. A retaining mechanism, such as endcap 20 and frit retainer 30, prevents the upstream porous member 14 from moving in the upstream direction along axis 11. The downstream porous member 16 is similarly held in position inside the bore of the body 9, or pressed against the downstream end of the body 9, by using a retaining mechanism such as the endcap 20 and frit retainer 30.

Depending on the way the retaining plug 18 is fastened to the tubular body 9, the downstream porous member 16 may need to be installed before the retaining plug 18, or after the plug 18. Typically, the bore is formed in the tubular body 9 and then each opposing end of the body is machined (e.g., drilled, bored, end milled) to form a shoulder 56. The retaining plug 18 is inserted to rest against the upstream shoulder 56 and affix the retaining plug to the body 9, preferably by a press fit or as otherwise described herein. Usually, once the body 9 has the retaining plug 18 fixed to the boy then the downstream porous member 20 is fixed to the body. A downstream porous member 16 is inserted from the downstream end of the body 9 so it rests against the downstream shoulder and the downstream frit retainer 30 and downstream end cap 20 are attached to hold the downstream porous member in place. Any cleaning arising from fastening the retaining plug 18 to the body 9 is performed before the downstream porous member is connected to the body.

The empty tubular body 9 before packing has the column 10 with downstream porous member 16 and retaining plug 18 defining an empty space in the bore of the tubular body 9 of predetermined length where the packed chromatographic bed will be formed between the plug 18 and the downstream porous member 28. For packing, the end fitting 22 and is connected to the tubular body 9 in order to form the fluid connections with the column, typically using threads 12 on the outside ends of the column. The upstream connection may be formed using end fitting 20, but typically a separate fluid packing connection is connected to the upstream end of the column, typically using threads 12 on the upstream end of body 9. A slurry of solvent and packing media 23 is forced through the passage 26 of retaining plug 18 with the downstream porous member 16 retaining the media 23 while allowing the solvent to pass through the downstream porous member and out the fluid connections of the downstream end fitting 22. The packing pressure and flow of slurry is preferably maintained until a predetermined amount of media is provided to the column 10. Typically, more media 23 is provided than is needed to fill the volume between the retaining plug 18 and downstream porous member 16 and form the desired packed chromatography bed 24 between the porous member 16 and plug 18. The excess media fills the passage 26 and may optionally extend above the retaining plug 18, depending on the packing process. The flow of solvent may continue after the flow of slurry containing media 23 is stopped. After the solvent flow is stopped and the slurry packing connection is removed, the body 9 will typically have some of the media extruded above the end of the tubular body 9. That excess media is scraped off and the upstream end fitting 20 and the upstream porous member 14 is fastened to the body portion 9, usually by threads on the end fitting mating with the threads 12 on the body portion, thus forming a completed column 10 suitable for chromatographic use. Depending on the column design, the end fitting 20 is tightened to place the upstream porous member 14 against the top surface of the retaining plug 18, or slightly inside the bore of the tubular body, or, at or slightly inside the upstream opening of the passage 26.

When the flow of packing slurry and solvent are stopped, the pressure on the packed chromatography bed 24 also stops and the bed will expand. The downstream end of the retaining plug 18 surrounding and defining the downstream opening of the passage 26 opposes that bed expansion. The part of the retaining plug surrounding the downstream opening of passage 26 and abutting the packed bed of chromatographic media is believed to stop all or substantially all the axial expansion of the packed chromatographic bed axially beneath that portion of the retaining plug abutting the media. Thus, the downstream opening of retaining plug 26 is preferably as small as possible while still allowing a large enough opening for good packing density and fast packing. Some media will usually extrude into the passage 26 through the downstream opening of passage 26, but that most that extruded media is believed to come from the area axially below the downstream opening, and perhaps the adjacent 10%-15% of the radial distance outward of the downstream opening in the retaining plug 18 which abuts the packed bed 24. For columns with bores of about 13 mm or less, with downstream openings having a diameter that is 10-35% of the bore diameter, substantially all (e.g., over 80%) of the media particles 23 extruded into the passage 26 are believed to come from the portion of the packed bed axially below the downstream opening of the passage 26 and the and the area surrounding that downstream opening and immediately below that opening. It is believed that a downstream opening of about 20% of the bore diameter is suitable for use and may maintain a packed bed 24, and that a downstream opening of between about 10% to 95% of the bore diameter is believed to offer advantages in the performance of the packed column 10.

It is believed that because the internal cylindrical wall of tubular body 9 is so smooth, the packed bed 24 will slide along the wall of the column and expand against or push against the downstream side of the retaining plug 18. Any voids arising from the packing process are believed to exist, if at all, in the corners of the plug 18 by the cylindrical bore or wall of the tubular body 9 and the expansion of the packed bed 24 is believed to fill any such void volumes as may arise during packing. The resulting packed column is believed to be substantially free of voids between the upstream and downstream porous members 14, 16, and to be under compression between those porous members as well as being under greater compression between the bottom or downstream end of the retaining plug 18 and the downstream porous member 16 and the. The retaining plug 18 is believed to maintain the packing pressure and resulting compression of the media bed 24—but the amount of compression retained depends on the size of the downstream opening of passage 26 and the diameter of the column, among other factors. The upstream porous member 14 is believed to restrain the expansion of the media in the passage 26 and any media above the retaining plug. The media in the passage 26 reaches atmospheric pressure upon removal of the fluid packing apparatus and the pressure in the passage 26 depends greatly on how fast the porous member 14 and end cap 20 are connected, as the expansion of the packed bed 24 into the passage 26 causes the media to push against the connected end fitting 20 and porous member 14 which resists expansion so as to determine the packing pressure in the passage.

The compression of the packed bed 24 is also reflected by the density of the packed bed. Preliminary testing on five columns showed improved performance. Five 150×4.6 mm columns were packed with 1.8μ porous media, packed using a retainer plug 18 with an included angle of about 20° for the conical passage 26a having an upstream opening of about 3 mm and a downstream opening of about 1.5 mm and an axial length of about 1.5-3 mm. That results in a downstream opening with a diameter of about 21% the bore diameter of the column 9. These columns were compared to five columns packed without the plug 18. Both types of columns were packed at 11 kpsi using the same slurry packing method. A comparison of ten columns packed using the same packing methods as used for a commercially sold column using porous material shows that the five columns using the retention plug 18, had an average density increase of 3.5% in the density of the packed bed 24 compared to five columns without the retaining plug 18. In addition to increased bed density, the columns packed with retaining plug 18 had noticeably improved peak asymmetry and increased efficiency.

Additionally, columns packed with the retaining plug 18 are believed to have noticeably improved stability performance over the same dimensioned, comparable column packed using the same media and slurry packing method. The columns for the stability test were packed at 10,500 psi pressure using the above described columns, media and in the case of one test column, the retainer plug 18. The test used 100 mM Sodium Phosphate pH 6.8 and 90/10 v/v 100 mM Sodium Phosphate pH 6.8/Isopropanol, at two different flow rates, 0.35 mL/min and 0.48 mL/min. All columns used the same sequence, which began and ended with the 100 mM Sodium Phosphate pH 6.8 at 0.35 mL/min for 20 minutes, with 441 minutes of running with 90/10 v/v 100 mM Sodium Phosphate pH 6.8/Isopropanol at the different flow rates followed by a 10 minute method with 100 mM Sodium Phosphate pH 6.8 with a linear ramp of flow from 0.48 to 0.35 mL/min, and a 10 minute flush of the column with 20/80 v/v Methanol/Water following the end of the sequence, followed by a removal of flow for eight hours. 24 injections were made at varying points during this sequence. The sequence of tests was repeated 12 times for a total column time of 105 hours. The sample was 2.50 mg/mL Thyroglobulin, 5.00 mg/ml: Immuno-Globulin G, 2.50 mg/mL Ovalbumin, 1.25 mg/mL Myoglobin, 11 mg/mL Uridine dissolved in Water, with an injection volume of 0.7 μL. The efficiency of the Uridine peak was tracked throughout as was the backpressure. Columns were considered to have failed the test after a loss of more than 25% of the original efficiency of this peak. The standard column failed after 20 column hours while the column with the retaining plug 18 lasted approximately 90 hours.

It is also believed that the particle packing media 23 interlocks when it forms the packed bed 24 and that the lateral interlocking of axially compressed particles cause the bed to move as a single unit so that restraining the outer periphery of the packed bed 24 from axial expansion around the smooth walls or bore through the column helps to restrain the entire bed if the retaining plug 18 extends far enough inward from the wall or bore of the column. It is believed that the smaller the size of the downstream opening of the passage 26, the greater the interlocking and the greater the resistance to axial expansion of the packed chromatography bed 24. The packed bed 24 may dome upstream where the passage 26 is located so that part of the packed bed 24 is extruded along axis 11 and into the passage 26, but a predominant part of the entire packed bed 24 remains compressed and does not extrude itself through the passage 26.

The rate over time at which media 23 from packed bed 24 is extruded into the passage 26 decreases quickly, but may continue at a decreasing rate depending on the slurry thickness, the size of media particles 23, the compaction pressure of bed 24 and the slurry packing pressure, the diameter of the packed bed 24, and the size of the opening of the passage 26 abutting the packed chromatographic bed 24.

It is advantageous to stop any extrusion of media particles 23 from the packed chromatographic bed 24 into the passage 26 as soon as practical. Stopping this extrusion is achieved by the upstream porous member 14 (e.g., upstream frit) and whatever mechanism is used to hold that upstream porous member in place. The retaining plug 18 retains the bed from gross expansion and the upstream porous member is used to stop any gradual extrusion of the particles 23 of packed bed 24 through the passage 26 in that retaining plug 18.

After the upstream end fitting 20 is removed (if present) and the connections for fluid packing are removed, and any extruded media is scraped off or otherwise removed, the upstream porous member 14 is then placed over the column to stop axial movement of the packing 23 extending into the passage 26 and thus limit and stop any gradual bed expansion arising from extrusion of particles 23 into passage 26. The porous member 14 is advantageously held in position by upstream end fitting 22, which is tightened through threads mating with column threads 12 (or other tightening and fastening mechanisms) to push the upstream porous member 14 against the media 23 above the retaining plug 18 and stop and/or limit expansion of the media 23 upstream of the retaining plug 18 and downstream of the upstream porous member 14. In short, the end fitting 20 pushes the porous member 14 against the media 23 in and above the porous plug 18 to stop extrusion of the packed bed 24 and media 23 through the passage 26. As the porous plug 18 stops the great majority of bed expansion and as the upstream porous member 14 stops gradual reduction of the bed expansion, the parts cooperate to fix the bed compression and to stop bed expansion. The retaining plug 18 locks-in a portion, and preferably a substantial portion, of the compression that the compressed chromatography bed 24 undergoes during fluid packing. The downstream opening in plug 18 allows the locked-in compression to be gradually released but to an extent that depends on the configuration of plug 18 and passage 26. The upstream porous member 14 stops the bed from extruding into passage 26 to stop and limit the loss of bed compression through passage 26, and is believed to result in a compressed bed 24 having a packing density substantially greater than the packing density in the passage 26.

As noted above, the packed chromatography bed 24 is believed to slide along the smooth bore of the chromatography column so that the retaining plug 18 need not necessarily extend across the entire upstream end of the bed and restrain all or almost all of the bed compression from being reduced by bed extrusion through the passage 26. The amount of peripheral restraint by the bottom surface of the restraining plug 18 is related to the size of the opening of passage 26 at the downstream end of the restraining plug 18. As noted above the size of the opening for passage 26 depends on numerous factors, including slurry and solvent composition, particles size, particle type, particle interlock, bore diameter and packing pressure, among others. The passage 26 must funnel or guide the slurry through the passage without clogging yet allow enough axial restraint by the remainder of the restraining plug 18 to resist axial bed expansion as much as possible.

It is believed that the size of the downstream opening of passage 26 is preferably between about ⅕ and ⅓ the diameter of the bore in tubular body 9 or the outer diameter of the retaining plug 18. Larger diameters allow faster filling and less clogging of the slurry but provide less restraint against axial bed expansion and provide a larger opening for potential extrusion of particles 23 which reduces the bed compression. It is nonetheless believed that the opening on the downstream end of the passage 26 may comprise as much as 95% of the bore diameter in the tubular body 9 during use, but that is not as preferred as it is believed to result in an undesirable amount of extrusion into the passage 26 and accompanying bed expansion. It is believed more preferable to have the size of the downstream end of the passage 26 be about 0.5 to 0.7 times the diameter of the bore through the column. More preferably, it is believed desirable to have the size of the downstream end of the passage 26 be about 0.3 to 0.5 time the diameter of the bore through the tubular body 9. And ideally, it is believed that a diameter of the opening in the downstream passage of about 0.2 to 0.35 the diameter of the column is preferred. Smaller diameters are believed suitable but are subject to risk of clogging with thicker slurries or larger particles of media 23 when the column bore diameters are under 5 mm. For large columns 11 with bores over 1 inch (25.4 mm) in diameter, a passage 26 with an opening diameter of about 13 mm or larger are believed suitable to prevent clogging but may be too small to ensure uniform packing of the bed across the bore diameter. The slurry containing the chromatographic media particles 23 passes through these various sized openings under a packing pressure selected to form the packed chromatography bed 24.

In one preferred embodiment using porous media particles 23 about 2 micron in diameter in a column having a bore diameter of about 5 mm, the upstream inlet opening of passage 26 was about 2 to 2.5 times larger than the diameter of the downstream, outlet opening of the passage, with the respective diameters being about 3 to 1.5 mm. It is believed desirable to have the upstream, inlet opening of passage 26 be about 2-5 times the diameter of the downstream, outlet opening of passage 26, for retaining plugs 18 that are less than 10 mm thick along axis 11.

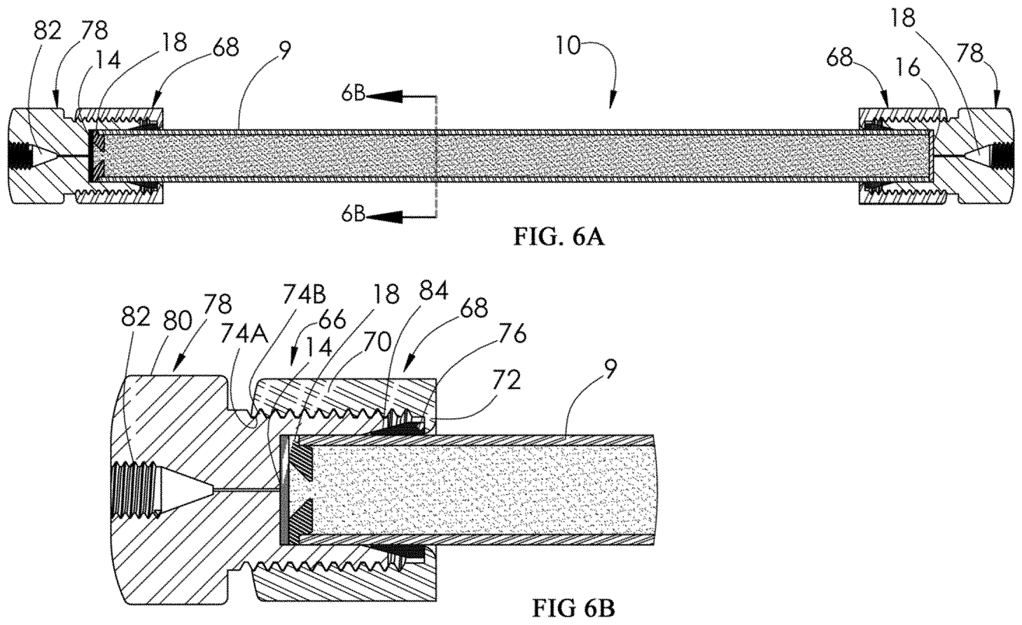

Referring to FIGS. 1-4, the position of the retaining plug 18 in the body 9 of the column 10 as measured along the axis 11, is preferably known and consistent to allow columns with known lengths of media beds 24 to be made. The effective length of such columns is typically determined by the distance of the packed bed of chromatographic media 24, which corresponds to the distance between the downstream surface of the retaining plug 18 and the upstream surface of the downstream porous member 16. The porous members 14, 16 are typically flat discs. The downstream end of the retaining plug 18 is preferably flat, but may have other shapes as shown in FIGS. 5A-5I and 6, and as described herein.

The inclination angle of the upstream portion of passage 26 was partially discussed above in terms of avoiding damage to the media particles 23 in the passage and above the retaining plug 18 during fluid packing. The optimum inclination angle for a conical passage 26 will vary with the media type, media size, slurry (thick or thin), solvent, downstream opening size of passage 26, packing pressure and the thickness of the plug 18 along the axis 11. An included angle for conical passage 26 of about 10-120 degrees is believed suitable, with angles of about 15-40 degrees believed to be more desirable, and an angle of about 20 degrees believed preferable, at least for a bore about 1-5 mm in diameter, about 2-4 mm in length, and using porous media particles 23 about 2 microns in diameter.

It is believed that the passage 26 may have suitable shapes other than the conical shape that extends through the entire axial thickness of the retaining plug 18 and passage 26a of FIG. 5A. Various shapes believed suitable for passage 26 are shown in FIGS. 5A through 5I and as described herein. FIG. 5B shows a passage 26b having a converging (in a downstream direction), conical upper portion or inlet 40 in fluid communication with and joining to a cylindrical downstream portion 42 which preferably opens onto a downstream side of the retaining plug 18. The minimum cross-sectional area of this passage 26b is determined by the cylindrical downstream portion 42.

FIG. 5C shows a retaining plug 18 having a fluid passage 26c with a converging, conical inlet 40 having a very small angle of inclination relative to the axis 11 through the retaining plug, with a downstream cylindrical portion 42 having an axial length larger than the axial length of the conical inlet 40 and exceeding a majority of the axial length of the plug 18 along axis 11. An axial length of the conical inlet 40 of about 20-45% of the axial length of the cylindrical portion 42 is believed suitable, with a minimal angle of inclination of about 5-10° believed suitable on the conical inlet portion 40.

FIG. 5D shows a retaining plug 18 having a fluid passage 26d with a converging conical inlet 40 having a very large diameter and a very large angle of inclination relative to the axis 11 through the retaining plug, about 140°-170°. A downstream cylindrical portion 42 has an axial length larger than the axial length of the conical inlet 40. In the depicted embodiment, the inlet portion 40 is shallow with an axial length about ⅕ that of the outlet portion 42. The relative axial lengths may vary. The minimum cross-sectional area of this passage 26e is determined by the cylindrical downstream portion 42.

FIG. 5E shows a retaining plug 18 having a fluid passage 26e with a cylindrical portion 42 extending entirely through the plug, from the inlet to the outlet. This embodiment is believed suitable to restrain expansion of the packed chromatography bed 24 but is believed to require lower packing pressures and flow rates when the media 23 is more fragile or the packing pressure is high because the lack of inclined sides on the upstream entry to the passage 26e is believed to damage the media and generate fines under high flow rates and high packing pressures.

A cylindrical upstream portion as shown in FIG. 5E is believed suitable to combine with any of the diverging downstream openings described herein and especially with the conical downstream opening 44 shown in FIG. 5I described later. It is also believed suitable to use a concave opening, such as a spherical shape, or the modified spherical shape of surface 46 (FIG. 5G) having rounded interior corners encircling a flat bottom, or the parabolic shape of surface 48 (FIG. 5H) as a downstream portion of the passage 26e. Thus, it is believed possible to use the restriction plugs shown in FIGS. 5B-5D and 5F to 5H in an inverted orientation with the cylindrical portion of the passage forming the upstream end of the passage. Thus, while the upstream opening of passage 26 is preferably larger than the downstream opening, it is believed that the upstream opening of passage 26 may be of smaller diameter than the diameter of the downstream opening, but less preferable for the reasons mentioned herein.

FIG. 5F shows a T-shaped or hat-shaped retaining plug 18 having a fluid passage 26f with a converging, conical inlet 40 having a relatively large angle of inclination relative to the axis 11 through the retaining plug. The downstream cylindrical portion 42 has an axial length much smaller than the axial length of the conical inlet 40. An axial length of the conical inlet of up to about 80-90% of the axial length of the thickness of the retaining plug along axis 11 is believed suitable. The retaining plug 18 has a larger diameter top portion 60 and a smaller diameter downstream portion or bottom portion 58, forming shoulder or flange 21. The shoulder 21 rests on the top of the tube 9, or on an internal shoulder in the tube 9 (not shown) during use. The shoulder 21 and resulting larger diameter of the retaining plug provide additional options for fastening the retaining plug 18 to the column 10. The minimum cross-sectional area of this passage 26f is determined by the cylindrical downstream portion 42.

FIG. 5G shows a retaining plug 18 having a concave inlet portion 46 with curved downstream corners, preferably circular corners, and more preferably with the inlet portion 46 being spherical and intersecting a cylindrical downstream portion 42. Thus, a cross-section of the passage 26g, has an inlet portion with rounded corners or a spherical inlet portion 46. The minimum cross-sectional area of this passage 26g is determined by the cross-sectional area of the cylindrical downstream portion 42.

FIG. 5H shows a retaining plug 18 having a concave recess that advantageously forms a parabolic shaped inlet portion 48 with a cylindrical downstream portion 42 in the fluid passage 26h. Thus, the cross-section of the passage 26h forms a parabola shape in the inlet 48. As with the other variations of the passage 26, the relative length of the upstream and downstream portions along axis 11 may vary.

Referring to FIG. 5I, the insert plug 18 has passage 26i having a converging conical inlet passage 40, a downstream (and intermediate) cylindrical passage 42, and a further downstream, diverging conical outlet portion 44. The minimum cross-sectional area of this passage 26i is determined by the cross-sectional area of the cylindrical passage 42. The surface finish on the diverging conical portion 44 is preferably rougher than the surface finish on the converging conical inlet passage 40 and the intermediate portion 42, and may be rougher by a factor of at least 10 but preferably not so rough as to create turbulent flow during fluid packing and not so rough as to damage the abutting surfaces of media particles 23 and generate fines. The increased surface roughness on the portion of passage 26 facing the packed bed 24 is believed to help reduce the expansion of the media bed 24 through the intermediate portion 42 while the smoother surface on the portion of the passage 26 facing upstream is believed to facilitate the slurry flow through the passage 26 and into the tubular body 9 to form the packed bed 24.

The converging conical portion 40 is configured much as described above except extending a shorter distance along axis 11. The intermediate cylindrical portion 42 is believed to help avoid any sharp edges that may damage media particles 23 as they pass through the retaining plug 38. The diverging conical portion 44 is believed to help disperse the slurry of media and achieve better packing of columns, especially columns with a bore diameters that are large. The use of multiple passages 26 as discussed later may help alleviate packing issues arising from a single passage or from the shape of the passage 26. The diverging conical portion 44 is also believed to reduce expansion of the packed bed 24 after the fluid packing pressure is stopped. The inclined surface of the downstream conical portion 44 is believed to offer resistance to upstream movement along axis 11 while directing particles inward to increase the interlocking of the media particles 23 and clog the conical portion 44. It is important that the downstream conical portion 44 be unmoving in the axial direction to minimize expansion of the packed bed 24 when the packing fluid pressure is stopped. It is also important that the retaining plug 18 be unobstructed and open to flow of the slurry and packing media 23 for packing to avoid clogging the passage 26 during packing.

The relative dimensions of each conical portion 40, 44 vary with the same parameters discussed above regarding conical passage 26. The diameter of the intermediate portion 42 is believed to depend on the same factors as the downstream opening of passage 26. The diameter of the intermediate portion 42 is preferably about the same size as the downstream opening in passage 26, although it is believed that the intermediate portion 42 may slightly smaller (5-20% smaller in diameter) than the downstream opening in passage 26 for the same column. The maximum diameter of the downstream conical portion 44 is preferably smaller than the maximum diameter of the upstream conical portion 42. It is believed that the inclination angle of the downstream, conical portion 44 should be greater than the inclination angle of the upstream conical portion 42 so as the bed expansion pushes media particles 23 inward toward axis 11 more than it does axially along axis 11, thus increasing particle interlock and clogging the passage 36. In the depicted embodiment, the upstream conical portion 40 has opposing walls inclined at an included angle of about 50° while the downstream conical portion 44 has opposing walls inclined at an inclined angle of about 80°. When the downstream walls are inclined at an over 90 degrees included angle, then the particles move inward toward axis 11 more than they move axially along axis 11, and that increased lateral movement may increase the particle interlock and clogging of the passage 26. Thus, it is believed advantageous to have the included angle of any downstream portion of the passage 26 being 90° or greater than 90°. As the included angle approaches 180° the inward movement toward axis 11 decreases. Inclined angles of about 45°—80° relative to axis 11 for conical walls forming the downstream portion of passage 26 are believed suitable, and this corresponds to an included angle of about 90°-160°.

The concept of using a restraining plug 18 to lock the bed in a compressed, axial position and restrain axial expansion of the bed is believed applicable to columns 10 that vary in diameter from a small bore a fraction of an inch in diameter (e.g., 0.040 inches or about 1 mm) to columns that are several inches in diameter (e.g., 4 inches or about 100 mm). The thickness of the retaining plug 18 along axis 11 is believed suitable to vary from about 0.004 inches (for smaller diameter bores of a few mm) to about 0.7 inches (for larger, 4-inch diameter bores). Columns with an internal diameter smaller than 1 mm are believed unsuitable with this method and apparatus. For retaining plugs 18 having the passage 26i, it is believed suitable to have the plug 38 about 0.004 inches thick along axis 11, with the upstream diameter of the upstream cone 40 about the same as the bore diameter of the column, although it is believed preferable that the cone diameter be slightly smaller than the bore diameter so for a 0.005 inch bore a cone opening of 0.0045 is believed preferable. The downstream opening of cone 44 could have the same dimensions as the upstream cone 40. On the other extreme, for bore of about 4 inches in tubular body 9, a retaining plug with passage 26i with a maximum diameter of about four inches on the upstream conical portion 44 for a four inch bore in the tubular body 9 is believed suitable, with a maximum diameter of about 3.5 inches for the intermediate cylindrical portion 42, with the diameter of the downstream conical portion 44 being the same as the upstream portion.

In all the variations of retaining plug 18, the passage 26 and especially the upstream portion of passage 26 is filled with media particles 23 during the packing process and that media is restrained from further expansion by the upper porous member 14. Thus, the retaining plug 18 is believed to retain the majority of the expansion of bed 24 while the porous member 14 retains expansion of media 23 in passage 2, which in turn is believed to limit expansion of bed 24 by blocking expansion through the downstream opening of passage 26.

The depicted first end fitting 20 of FIG. 1 is threaded onto the end of the column body 9 to urge the frit retainer 18 against the end of the column or body 9 or the retaining plug 18 against the annular shoulder 56 or annular end of the body 9 sufficiently to form a fluid tight seal suitable for use. As shown in FIGS. 6A-6B, a compression end fitting may also be used. It is also believed suitable for either end fitting 20, 22 to comprise a compression end fitting 66, or any other end fitting. The compression end fitting 66 has a hollow, annular nut 68 with a sidewall 70 (preferably cylindrical). One end of the nut 68 is open and the other end or bottom 72 has a centrally located hole that is slightly larger than the outer periphery of the body 9. The chromatography column body 9 is preferably cylindrical and the hole in the bottom 72 is preferably circular. The sidewall 70 is threaded and the figures show the inward facing side of the sidewall 70 as having threads 74A, but the outer side could be threaded.

A ferrule 76 is placed inside the collar 68 and rests on the bottom 72. The ferrule 76 has a central hole so it can slide over the outer periphery of the body 9. The ferrule has a conical shaped outer surface 77 that tapers inward toward the longitudinal axis of the body 9, and thus has a triangular cross section with the base at or adjacent bottom 72 and the tip of the triangle extending toward the open end of the collar 68. A fitting body 78 has a gripping surface 80 at a first end and a threaded surface 74B at its second end with the threaded surface sized so threads 74B threadingly engage threads 74A during use. A cylindrical cavity in the second end of the fitting body 78 receives the mating end of the body 9 that passes through the hole in bottom 72 and passes through ferrule 72. A threaded inlet and associated passage 82 extend along a central axis of the fitting body 78 to connect to the liquid chromatography equipment. A conical end 84 is formed on the second end of the fitting body and shaped to receive the conical outer surface 77 of the ferrule 76.

The nut 68 and fitting body 78 are rotated relative to each other causing mating threads 74A, 74b to move the nut and fitting body toward each other. As the threads 74A, 74B rotate relative to each other, the mating conical surfaces 84, 77 on the fitting body and on the ferrule, compress the ferrule 72 against the body 9 to grip the body 9 and fix the nut 68 in position along the length of the body 9. As the threads 74A, 75B rotate relative to each other, the top of the cavity in the fitting body 78 contacts the first porous member 14 and urges the first porous member 14 against the retaining plug 18 and toward the end of the body 9 to form a fluid tight seal sufficient for use of the chromatography column. The ferrule 72 is preferably of a suitable plastic, polymer or elastomer. The compression connection uses mating threads to move two inclined surfaces relative to each other along an axis and thus to clamp one inclined surface to a column. The general operation of a compression connection is believed known, but the adaptation for use to form a seal using the porous member 14 and the retaining plug 18 is believed to be new.

A similar construction is provided on the compression fitting at the second end of the column and body 9 and the description is not repeated. The second compression fitting, however, does not have a plug 18 and thus the fitting body 78 urges the second porous member 16 against the end of the body 9 to form the fluid tight seal sufficient for chromatographic use.

The method and apparatus disclosed herein are believed especially suited for use with HPLC columns and for UHPLC columns (ultra high pressure liquid chromatography columns), which each require metal bodies. HPLC media beds 24 typically use media particles of above 2μ (up to 20μ or more depending on the application), and are typically packed at pressures from 50 to about 10,000 or 12,000 psi. UHPLC media beds typically use media particles of 2μ or smaller and are typically packed from about 10-10,000 psi to about 25,000 psi. The retaining plug 18 is preferably constructed so that at these normal packing pressures the retaining plug 18 does not dome upwards. With smaller diameter columns 10 this doming is usually not an issue but when the column bores become larger as with 3-4 inch diameter columns, any doming of the plug 18 can noticeably affect the density of the packed bed 24. Thus, the retainer member 18 is preferably constructed stiff enough to avoid doming and fastened to the column 10 in a way to avoid doming, as well as to avoid axial movement of the retaining plug 18 that would reduce the packing pressure and reduce the bed density.

Locating the passage 26 in the center of the retaining plug helps relieve the maximum doming force on the retaining plug 18, and that also allows the retaining plugs to be maintained thinner in the axial direction than would be the case if the passage 26 were not present. Further, the laterally inward direction in which the downstream end of the retaining plug 18 may direct the media particles 28 and the increased interlocking of the media particles in the media bed 24 are also believed to help reduce the strength needed for the retaining plug 18 and thus to also reduce the axial thickness of that retaining plug.

The retaining plug 18 and the associated methods and apparatus described herein are especially useful for HPLC and UHPLC, and to accommodate the high pressures the body 9, plug 18, frit retainer 30 and end caps 20, 22 are preferably made of metal and more preferably made of stainless steel. The materials used will be suitable for the pressures and forces involved and the required connections. Thus, for example, a retaining plug permanently fastened to body 9 will be of suitable material for such permanent fastening and will withstand the desired packing pressures and operating pressures, including pressures exerted by the chromatographic bed 24 on the bottom of the plug 18 and any forces from the upstream porous member 14. For lower pressure applications, suitable plastics may be used. Thus, the method and apparatus described herein are also believed suitable for use with chromatography columns using plastic bodies, including solid phase extraction (SPE). The packing pressures believed most suitable for the method and apparatus described herein are believed to be above 100 psi and preferably several hundred psi for polymer particles, and more preferably from about 5,000 psi to 30,000 psi for silica and non-polymer particles, using current technology. The method and apparatus are believed suitable under even higher pressures.

The above method and apparatus use a retaining plug 18 permanently fixed to the body 9, with the upstream porous member 14 abutting the plug 18 and/or media particles 23 in the passage 26 and plug 18 and being added after slurry packing is completed. It is believed possible, but less preferable, that the retaining plug 18 need not be permanently fixed to the body 9 but can be stable during packing and allowed to move slightly downstream thereafter so that the retaining plug 18 and adjoining upstream porous member 14 can be moved downstream so the plug 18 further compresses the packed chromatographic bed 24 while the porous member 14 maintains the media in the passage 26 in compression to limit further media extrusion into the passage 26 during the movement of the retaining plug 18 after slurry packing. This post-packing can be achieved, for example, by using a retaining plug 18 having threads engaging mating threads on the body 9 so that rotation of the threaded retaining plug 18 moves the plug to further compress the packed bed 24. Prongs on the upstream end fitting 20 may pass through the upstream porous member 14 and engage recesses or peripheral shoulders on the retaining plug 18 to rotate the plug 18. Alternatively, the porous member may be press-fit into the bore of body 9 with sufficient force to maintain its axial position during packing, with the upstream end fitting 20 mating with threads on the column 10 or body 9 to urge the upstream frit retainer 30 against the retaining plug directly or through the upstream porous member 14, with sufficient force to move the retaining plug 18 downstream to compress the packed bed of chromatographic media 24. The axial movement of the retaining plug 18 and porous member 14 needed to compensate for the loss of bed compression caused by extrusion of media particles into and/or through the passage 26, is believed to be small, and measured in a fraction of a mm for columns less than about 12 mm in bore diameter and a few mm for larger, four-inch diameter columns.

The above description uses a single passage 26 through the retaining plug 18. It is believed suitable, and for larger diameter columns may be preferable, to use more than one passage 26. For small diameter bores in columns 10, it is impractical to use multiple passages 26 and not needed for achieving a uniformly packed chromatographic bed. For larger diameter columns, the use of multiple passages 26 is believed to increase the interlocking of media particles 23 in the packed bed 24, is believed to increase the retention of the bed compression and reduce the extrusion of media into passage 26 after the slurry packing flow is stopped. If multiple passages are used, it is believed advantageous to have the passages symmetrically located about longitudinal axis 11 and the shapes described herein are believed suitable. Thus, two passages 26 would be on diametrically opposing sides of the body 9 with passage centerlines the same radial distance from axis 11 and spaced 180° apart, while three passages 26 would be spaced 120° apart and located the same radial distance from axis 11. Four passages 26 could be spaced either 90° apart at the same distance from axis 11, or could have a center passage 26 centered on axis 11 with three, equally spaced outer passages 26. Retaining members 18 with larger numbers of passages 26 may have them in single rings or in concentric rings about axis 11, with or without a central passage on the axis 11.

If multiple passages 26 are used, it is believed that the retaining plug 18 may cover the entire bore of the body 9 and column 10, with each passage 26 having an overall smaller diameter portion in the passage than is possible than if a single passage 26 were used. If multiple passages are used the minimum diameter of the passage 26 must be large enough to prevent clogging. For 1.6μ diameter porous particles in a 4.5 mm diameter bore, a downstream opening in conical passage 26a of about 1.5 mm in diameter is believed suitable, while an opening diameter of 1 mm is believed subject to clogging. The 1.5 mm minimum opening diameter comprises about 9% of the cross-sectional area of the bore for the column 10 with a 4.5 mm diameter bore. It is believed that the minimum cross-sectional area of each of the multiple passages 26, when combined may be about 9-20% of the cross-sectional area of the bore of the column 10 and body 9, and preferable about 10-15% of that cross-sectional area, and more preferably about 12% of that cross-sectional area—for bore diameters up to at least 13 mm.

As the bore diameter of the column 10 increases, it is believed useful to use multiple passages 26 for fluid packing of the chromatographic bed 24 in order to more uniformly pack the bed and to create the packed bed faster. A number of small diameter passages 26 is believed to result in a more uniformly packed bed 24 and the smaller diameter passages 26 are believed to retain more of the bed compression, than a single, larger diameter passage. The number of passages 26, the shape and minimum passage diameters, and the location of the passages, will vary with the various factors discussed above, including particle size, particle type, column diameter and packing pressure, among others. Thus, it is believed that if multiple passages 26, are used, each having a smaller minimum passage diameter than required to achieve the same flow of packing slurry through a single passage, then a larger portion of the bed compression may be retained by the retaining plug 18, than if a single retaining plug 18 were used or than if no retaining plug were used in the slurry packing process. Multiple passages 26 are believed especially suitable for columns 10 with bore diameters of about 20 mm-100 mm, or larger, especially when packing porous media particles and/or when using packing pressures of over 20,000 psi.

The number of passages 26 used in a single retaining member 18 is believed to vary, depending most greatly on the diameter of the column bore and the media particles 23 being packed to form the chromatographic bed 24. For example, the area of a 1.5 mm minimum diameter passage 26a is about 1.8 mm² whereas the area of a 100 mm bore diameter (about 4 inch diameter) is about 8,100 mm². One passage 26a of 1.5 mm minimum diameter is believed suitable for a bore up about 4-10 mm diameter using 1.6μ porous particles 23 and that minimum diameter comprises about 14% of the area of the 4 mm diameter bore and about 2% of the area of the 10 mm diameter bore. In comparison, ten passages 26a each with minimum diameters of 1.5 mm will comprise about 170 mm² or about 2% of the area of a 100 mm diameter bore, while providing a large area to retain expansion of the compressed bed 24 formed by fluid packing. Thus, it is believed that numerous small diameter passages 26 of about 1.5-10 mm diameter, are believed suitable for fluid packing of column diameters up to about 100 mm (about 4 inches) in bore diameter, while retaining a majority (over 50%) of the bed compression, or even a substantial portion of 80-90% of the bed compression.

The above described packing methods are believed to result in upstream to downstream arrangement of the upstream porous member 12, the retaining plug 18 and its at least one passage filled with media 23, the packed bed of chromatographic media 24 and the downstream porous member 14, with no void spaces between the upstream and downstream porous members 12, 14, and with all media between the porous members 12, 14 being compressed. The retaining plug 18 is interposed between the upstream and downstream porous members 12, 14, with the retaining plug 18 at least partially restrain the downstream packed bed 24 of chromatographic media from expanding and decreasing the density of the slurry-packed bed, while the passage(s) 26 allow slurry packing of the chromatographic bed 24. This is believed to differ greatly from the prior art which compressed the chromatography bed between upstream and downstream fits, with no intervening structure. Further, when the retaining plug 18 is fixed to the tubular body 9 or column 10 during slurry packing, a substantial portion of the bed compression is believed to be retained by retaining member 18 without the need to axially compress the packed bed with a piston or other movable device.

The volume of the media in the passage(s) 26 is very small relative to the chromatographic bed 24, preferably about 0.5 to 5% of the volume of media in the bed 24. The media 23 in the passage(s) 26 is compressed at a first density or first compression pressure while the media forming the packed chromatography bed 24 is compressed at a second density or second compression pressure which is greater than the first density or first compression pressure. Thus, all chromatographic media between the porous members 12, 14 is believed to be compressed with the chromatographic bed 24 being more compressed or more densely packed than if the column had been packed without using the retaining plug 18.

The passages 26 are described as having various circular cross-sectional shapes, such as cones, cylinders, spheres, etc. Such shapes are typically easier to accurately form in metal parts. But the passages 26 need not be of circular-cross-sectional shapes and the passages 26 may thus be square, triangular, hexagonal, oval, elliptical or other shapes.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The above description is given by way of example, and not limitation. Given the above disclosure, one skilled in the art could devise variations that are within the scope and spirit of the invention, including various ways of fastening the retaining plug 18 to the body 9 so the retaining plug 18 does not move or deform axially, and various ways of retaining the plug 18 immovable relative to the body 9 during fluid packing while allowing movement of the retaining plug relative to the body 9 after packing to offset the loss of compression due to extrusion through the passage(s). Further, the various features of this invention can be used alone, or in varying combinations with each other and are not intended to be limited to the specific combination described herein. Thus, the invention is not to be limited by the illustrated embodiments.

1-49. (canceled)

50. A chromatography column having a tubular body with opposing upstream and downstream ends with upstream and downstream end fittings connected to the tubular body, the tubular body having an internal bore extending along a longitudinal axis of the tubular body and column, the column comprising:
a retaining plug blocking an upstream end of the bore and having a passage extending between upstream and downstream ends of the retaining plug and filled with a porous chromatographic media;
a downstream porous member blocking the downstream end of the bore, the bore having a continuous wall between the retaining plug and the downstream porous member; and
a slurry-packed bed of chromatographic media held in compression in the bore by the retaining plug and the downstream porous member;

51. The column of claim 50 further comprising an upstream porous member upstream of the retaining plug located to filter fluid flow through the bore into the at least one passage.

52. The column of claim 51, wherein the passage has a first diameter at the upstream end of the retaining plug and a second diameter at the downstream end of the retaining plug and the first diameter is larger than the second diameter.

53. The column of claim 50, wherein the first, upstream diameter of the passage is larger than the second, downstream diameter of the passage with the passage extending along the longitudinal axis, and wherein the retaining member is permanently fastened to the tubular body.

54. The column of claim 52, wherein the upstream end fitting holds the upstream porous member from moving in the upstream direction along the longitudinal axis.

55. The column of claim 52, wherein the fluid passage has a conical portion on the upstream end of the retaining plug, which conical portion converges in a downstream direction to a smaller diameter.

56. The column of claim 55, wherein the conical portion extends from the upstream to the downstream ends of the retaining plug.

57. The column of claim 50, wherein the downstream end of the fluid passage has an opening that is about ⅕ to about ⅓ the diameter of the bore.

58. The column of claim 50, wherein there are a plurality of fluid passages each having a minimum passage diameter.

59. The column of claim 52, wherein the chromatographic media comprises a polymer particle.

60. The column of claim 52, wherein the chromatographic media comprises a silica gel or modified silica gel.

61. A chromatography column, comprising:
a tubular body having opposing upstream and downstream ends and a cylindrical bore extending along a longitudinal axis of the tubular body between the upstream and downstream ends;
a retaining plug having an outer periphery permanently fixed to the bore adjacent the upstream end of the tubular body in a fluid tight manner, the retaining plug having a fluid passage extending through the retaining plug, the fluid passage having an upstream opening and a downstream opening;
a downstream porous member extending across the bore adjacent the downstream end of the tubular body, the downstream porous member configured to block the passage of chromatographic media while allowing liquid and gas to pass through the downstream member; and
a downstream end cap connecting the downstream porous member to the downstream end of the tubular body.

62. The chromatography column of claim 61, wherein the downstream end of the passage has a diameter that is smaller than a diameter of the upstream end of the passage, the fluid passage extending along the longitudinal axis.

63. The chromatography column of claim 61, wherein the tubular body is made of metal and the fluid passage has an upstream opening that is larger in diameter than the downstream opening.

64. The chromatography column of claim 61, wherein the retaining plug has an upper surface that is flush with the upstream end of the tubular body.

65. The chromatography column of claim 61, wherein the retaining plug has a hat shaped cross-section with a downstream portion extending inside the bore of the tubular body and an upstream portion extending over an end of the tubular body and permanently fastened thereto.

66. The chromatography column of claim 61, further comprising an upstream porous member upstream of and urged toward the retaining plug by an upstream end cap that urges a frit retainer toward the porous plug.

67. The chromatography column of claim 61, wherein the fluid passage is filled with porous chromatographic media and the bore between the downstream porous member and the retaining plug are filled with chromatographic media under compression.

68. The chromatography column of claim 67, wherein the column is packed with silica gel or silica gel based chromatographic media.

69. The chromatography column of claim 67, wherein the column is packed with polymer chromatographic media.
